(19) United States
(12) Patent Application Publication
(10) Pub. No.: US 2011/0154015 A1
(43) Pub. Date: Jun. 23, 2011

(54) Method For Segmenting A Data File, Storing The File In A Separate Location, And Recreating The File

(76) Inventors: Tareq Mahmud Rahman, North Andover, MA (US); Paul R. Senn, Salem, MA (US)

(21) Appl. No.: 12/862,793

(22) Filed: Aug. 25, 2010

Related U.S. Application Data
(60) Provisional application No. 61/284,543, filed on Dec. 21, 2009.

(51) Int. Cl. G06F 17/30; G06F 15/16; H04L 9/32; G06F 21/00

(52) U.S. Cl. 713/150; 707/827; 709/218; 726/3; 707/E17.01

(57) ABSTRACT

A method includes transmitting file identifying information to a dispatch server; receiving from the dispatch server a storage location identifier and a distribution algorithm identifier; performing the distribution algorithm to generate a distribution map for segments of the file; and transmitting the file segments to storage locations in accordance with the distribution map. The distribution map indicates for each file segment a segment size and a storage destination for that segment. The storage location identifier may identify a server cluster; the dispatch server and the server cluster may be located at a third-party facility physically and/or logically remote from the client. A plurality of distribution algorithms may be provided, so that the distribution algorithm and the distribution map for one stored file are distinct from the distribution algorithm and the distribution map for another stored file.

### CROSS-REFERENCE TO RELATED APPLICATIONS

This application claims the benefit of U.S. Provisional Application No. 61/284,543, filed Dec., 21, 2009.

### FIELD OF THE DISCLOSURE

This disclosure relates to data file management, and more particularly to methods for storing a file in a segmented fashion in a plurality of separate logical and/or physical locations, and retrieving and re-assembling the file.

### BACKGROUND OF THE DISCLOSURE

The concept of dividing a data file into multiple segments, and storing and retrieving those segments, has been implemented in a variety of computing environments. Generally, the purpose of file segmentation and segmented storage is to improve the performance of local file systems and to prevent data loss in the event of a hardware failure. One example is the use of file segmentation in disk storage systems using RAID technology.

However, file segmentation techniques (including RAID technology) typically do not use different methods of file segmentation for different users or for different files. Furthermore, these techniques do not address security requirements, either for local file systems or network-based file systems.

It is desirable to implement a file segmentation, storage and retrieval method for distributing a file over multiple systems, where only a local area network (LAN) is used to distribute a file, as opposed to sending an entire file over a wide area network (WAN) such as the Internet. In addition, it is desirable to use such a file segmentation method in addition to existing access control, authentication and encryption techniques, in order to implement an offsite or onsite storage solution with a high level of security.

### SUMMARY OF THE DISCLOSURE

The present disclosure provides a method and system for securely storing and retrieving segmented data files.

According to one aspect of the disclosure, a method includes the steps of transmitting identifying information for the file to a dispatch server; receiving from the dispatch server a file identifier, a storage location identifier, and a distribution algorithm identifier; performing the distribution algorithm in accordance with the received distribution algorithm identifier; generating a distribution map for segments of the file in accordance with the distribution algorithm; and transmitting the file segments to one or more storage locations in accordance with the distributioner map. The client device can be any device with LAN or WAN connectivity, including mobile phones, PDAs and similar devices, and the client side software can be implemented in such a way that the assembled file is never stored on disk, but only retained in memory and destroyed when the user is done viewing the file. Also the client-side software can be implemented in such a way that it does not persist on the machine after the user has finished viewing the file. This is especially relevant for scenarios where the user is making use of a device which is not his own, or which he cannot be sure will remain secure, such as a computer in a library or a mobile device, which may be stolen. In embodiments of the disclosure, the method may be performed by a dispatch server, with the transmitting performed over a wide-area network (WAN). The storage location identifier may identify a server cluster; the dispatch server and the server cluster may be located at a third-party facility that is physically and/or logically remote from the client. In addition, a plurality of distribution algorithms may be provided, so that the distribution algorithm and the distribution map for one stored file are distinct from the distribution algorithm and the distribution map for another stored file. The distribution map indicates for each file segment a segment size and a storage destination for that segment.

According to another aspect of the disclosure, a system for storing and retrieving a data file includes a client system; a dispatch server connected to the client system; and one or more storage locations for storing segments of the file. The dispatch server is configured to transmit to the client system a file identifier, a server cluster identifier indicating the storage location, and a distribution algorithm identifier. The client system is configured to execute a client application for performing a distribution algorithm identified by the distribution algorithm identifier; generating a distribution map for segments of the file, in accordance with the distribution algorithm; and transmitting the file segments to the storage location in accordance with the distribution map. In embodiments of the disclosure, the system also includes a web server connected to the dispatch server; the web server is configured to receive user authentication information from the client system.

The foregoing has outlined, rather broadly, the preferred features of the present disclosure so that those skilled in the art may better understand the detailed description of the disclosure that follows. Additional features of the disclosure will be described hereinafter that form the subject of the claims of the disclosure. Those skilled in the art should appreciate that they can readily use the disclosed conception and specific embodiment as a basis for designing or modifying other structures for carrying out the same purposes of the present disclosure and that such other structures do not depart from the spirit and scope of the disclosure in its broadest form.

### BRIEF DESCRIPTION OF THE DRAWINGS

FIG. 1 is a schematic illustration of a system in which a segmented file may be stored in a plurality of separate logical and/or physical locations, in accordance with an embodiment of the disclosure.

FIG. 2 schematically illustrates storage of file segments in different storage units, in accordance with an embodiment of the disclosure.

FIG. 3 is a flowchart illustrating a process for distributing and storing segments of a file, according to an embodiment of the disclosure.

FIG. 4 schematically illustrates a distribution map for segments of a file generated by an application on a client system, in accordance with an embodiment of the disclosure.

FIG. 5 is a flowchart illustrating a process in which a distribution map is generated by encrypting a file identifier, in accordance with another embodiment of the disclosure.

FIG. 6 schematically illustrates retrieval of file segments from different storage units, in accordance with a further embodiment of the disclosure.

FIG. 7 is a flowchart illustrating a process for retrieving segments of a file and reassembling the file, according to an embodiment of the disclosure.

### DETAILED DESCRIPTION

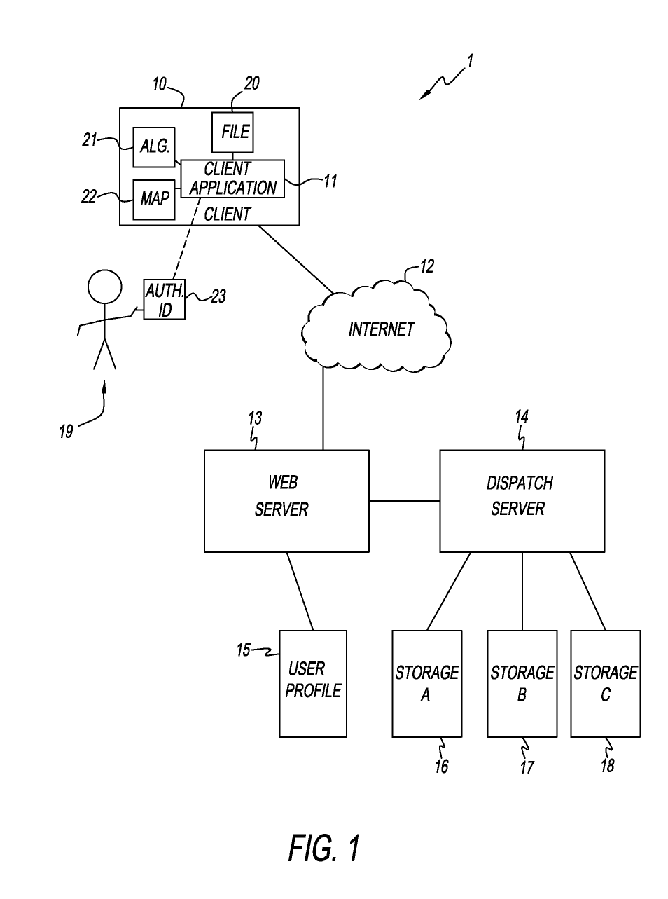

A system 1 for storing and retrieving segmented data files, according to an embodiment of the disclosure, is shown schematically in FIG. 1. A client system 10 has a custom application 11 (a client application) running thereon; system 10 connects via a public WAN (e.g. the Internet 12) to a custom developed web server 13, which may be located at a third-party provider's facility (e.g. ISP, ASP, etc.). Web server 13 connects to another custom application, here referred to as a dispatch server 14, also running at a third-party provider's location. The web server and dispatch server are connected to remote storage units 15-18 which may be also located at third-party facilities. User 19 of the client application 11 has no control over the web server, dispatch server or the remote storage facilities (also called storage servers). In this embodiment, there is no limit to the number of client systems, storage servers, web servers, or dispatch servers which may be deployed.

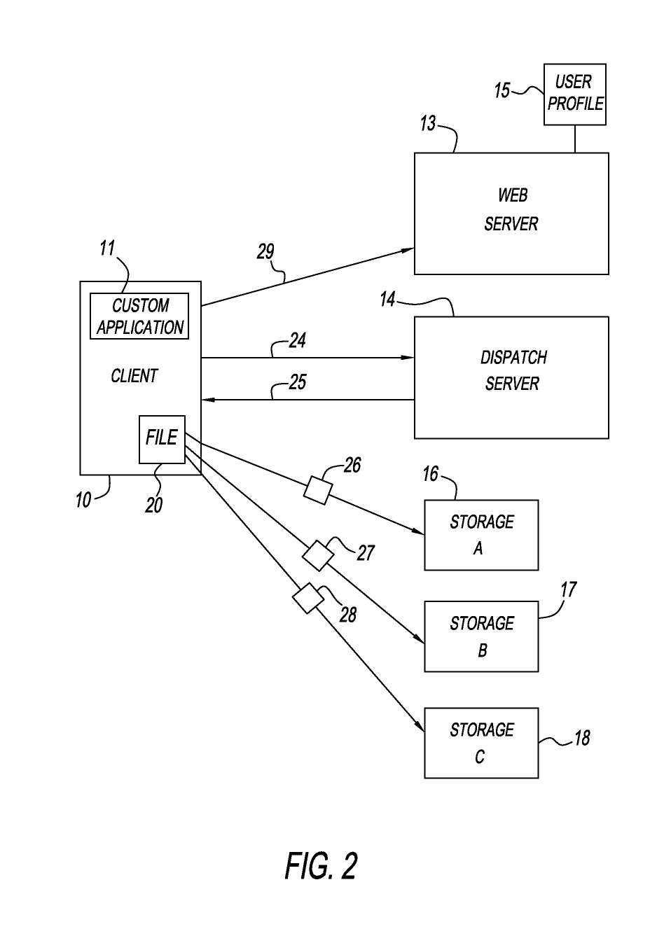

Use of system 1 in a file storage process, in accordance with the disclosure, is illustrated schematically in FIG. 2. When it is desired to store file 20, client 10 executes client application 11 and identifies the file. File 20 may be in any format, and in particular may be either plaintext or encrypted. Client application 11 executes a publicly available algorithm to connect to web server 13; a sign-on message 29 to web server 13 typically includes client identifying information and security information (e.g. one or more passwords) which is compared with a stored user profile 15. The client application then makes a transmission 24 to the dispatch server, sending specific file information relating to file 20 (e.g. a file name, file size, date last stored/retrieved/modified, etc.). The dispatch server sends a response 25 including a unique identifier for the file, a server cluster identifier (indicating a storage location for the file) and a distribution algorithm identifier for the file. The distribution algorithm is used to determine how file 20 is to be segmented. Client 10 subsequently transmits segments 26-28 respectively to the various storage facilities 16-18.

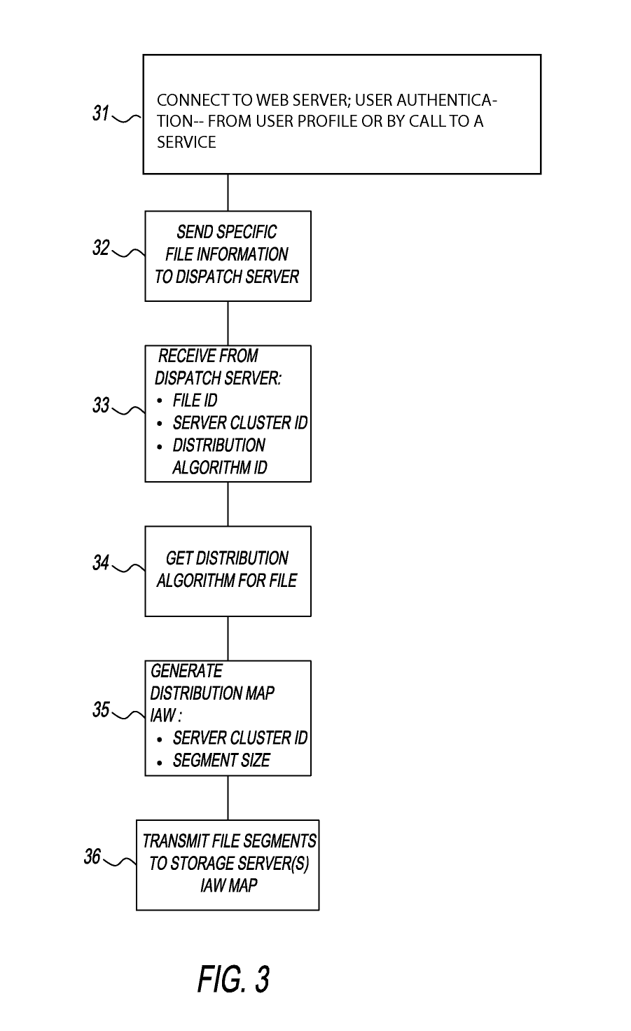

Details of a process for distributing and storing file segments in the various storage facilities are illustrated in the flowchart of FIG. 3. User 19 connects to the web server 13, which thereupon performs a user authentication process or the server may be authenticated with credentials from a service that is currently being used such as, for example, Facebook, Thus, the user profile may be locally attached storage to the web server or may be remote, (step 31). In this embodiment, every user has an authentication identifier 23, assigned to the user when the user's account was created using the custom application 11, in addition to a user identifier (username). The specific file identifiers are sent via transmission 24 to the dispatch server 14 (step 32). In step 33, the client receives the unique file identifier, the server cluster identifier, and an identifier for the distribution algorithm to be used. Distribution algorithm 21 is known to both the client application 11 and the dispatch server 14, but is not transmitted over the WAN at the time of file storage. Both client system 10 and dispatch server 14 may have access to multiple distribution algorithms; a different distribution algorithm may be used not only by each user, but also for each file stored by that user.

Client application 11 then gets the distribution algorithm 21 corresponding to the identifier transmitted from dispatch server 14 (step 34). The client application then generates a distribution map 22 for the file in accordance with algorithm 21 (step 35). The client then transmits the file segments to one or more storage servers in accordance with the distribution map (step 36).

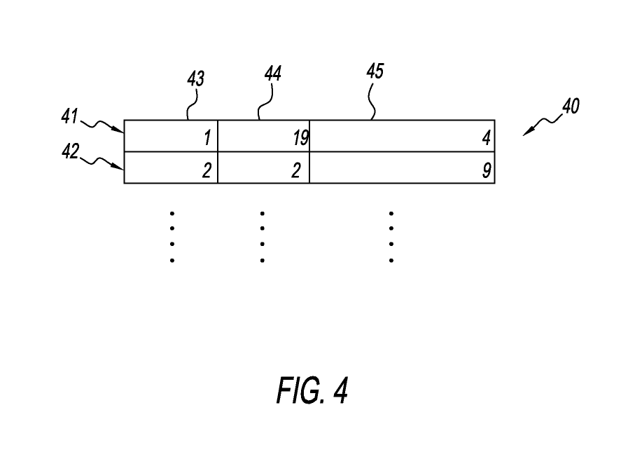

The distribution map defines the segmentation of the file, and the storage destination for each segment. In an embodiment, the distribution map is an array 40 with entries 41, 42, etc., one entry corresponding to each segment of the file (see FIG. 4). Each entry has 64 bits, where a first group 43 of 16 bits forms a file server identifier (or a value which may be used to derive a file server identifier), a second group 44 of 16 bits indicates a number of bytes of random data, and the final group 45 of 32 bits indicates a segment size (or a value which may be used to derive a segment size). In the example of FIG. 4, the first entry 41 indicates that 19 bytes of random data (that is, data not in the file of interest), followed by 4 bytes of actual data, should be written to a file server designated 1 in the cluster indicated by the server cluster identifier passed to the client.

The number of array entries in the distribution map corresponds to the number of segments. The maximum number of array entries needed for a given file is equal to the number of bytes in the file; in a case where each segment is one byte, an array entry is needed for each byte of the file. In the distribution map 40, each entry is 64 bits or 8 bytes; the maximum size of the distribution map would be 8 times the size in bytes of the file 20.

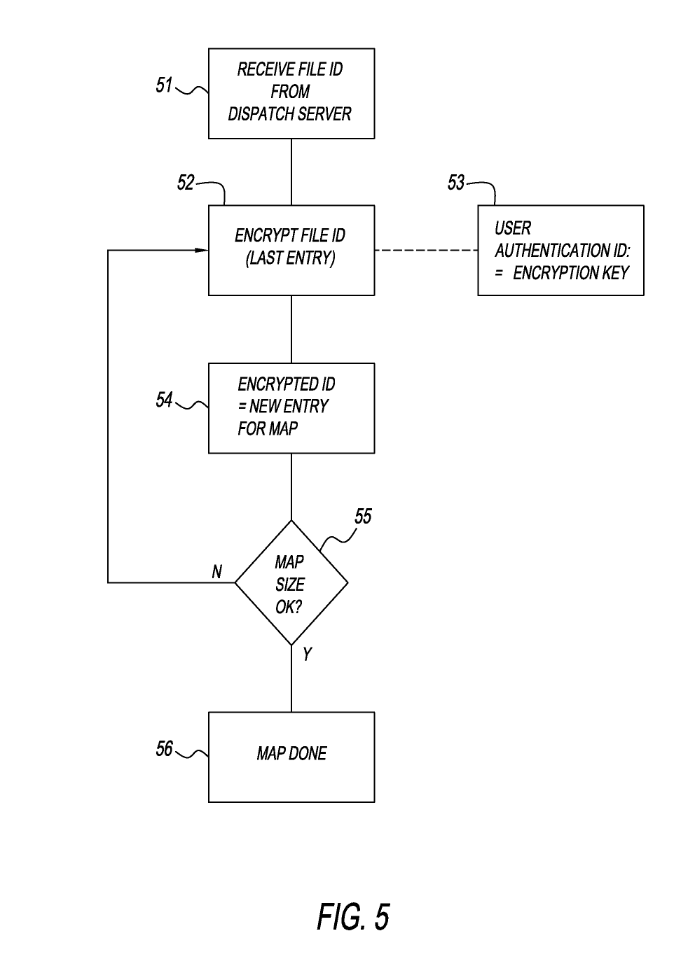

Another process for generating a distribution map, according to a further embodiment, is shown in the flowchart of FIG. 5. In this embodiment, entries in the distribution map are constructed using encryption. The client receives a unique file identifier from the dispatch server (step 51); this file identifier has a specified length, e.g. 128 bits. Using the authentication identifier 23 as an encryption key 53, the file identifier is encrypted (step 52) so that the encrypted result is the same length as the original data (for example, by using a block cipher). The encrypted file identifier becomes the first entry of the distribution map (step 54). This process is repeated, by encrypting the last encrypted value, multiple times until the map has a size adequate to cover the file (steps 55, 56). All of the various entries in the map will have the same size (in this example, 128 bits). Their exact values are not critical to the process, since a valid file server identifier can be derived from each given entry; for example, by using a modulo function to obtain a value in the necessary range to serve as a valid file server identifier. It should be noted that this process is both repeatable (that is, the same output is always obtained from the same input) and secure (since the user's authentication identifier serves as the key). Furthermore, the map itself is not transmitted over the Internet. The client and the dispatch server are able to construct the map using algorithms and identifiers already available to each.

The client application 11 transmits the file 20 in segments 26-28 to secure servers 16-18. As noted above, the file may have any number of segments up to the number of bytes in the file; likewise, the number of possible different storage locations is limited only by the number of segments. Each secure file server may be hosted by a different provider, be in a different authentication domain, and/or be in a different physical location.

The file segments may be transmitted to the storage locations either serially or in parallel. The destination storage locations may be defined when the file is segmented, or when the user is established by the client application. A given storage destination may be distributed across multiple physical and/or logical locations.

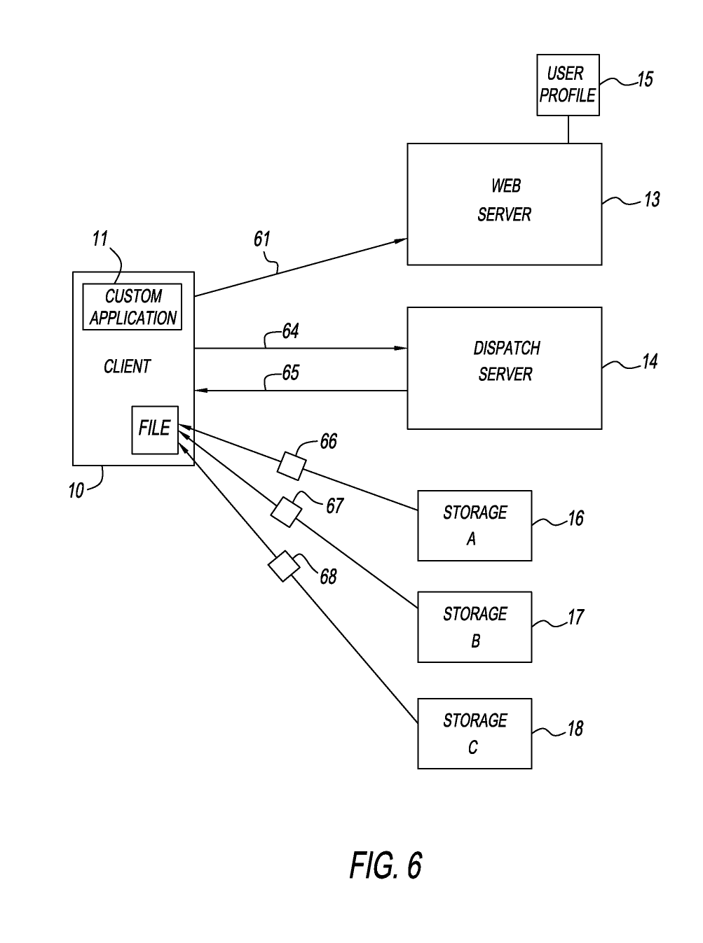

Use of system 1 in a file retrieval process is shown schematically in FIG. 6. The user is authenticated after making a transmission 61 with required authentication information to the web server 13. The server may be authenticated with credentials from a service that is currently being used such as, for example, Facebook. A filename, indicating the file to be retrieved, is sent from client 10 via a transmission 64 to the dispatch server 14. The response 65 from the dispatch server includes the file identifier, the server cluster identifier and the distribution algorithm identifier, as in the file storage process. The client re-assembles the file from the necessary file segments 66-68, retrieved from the storage servers.

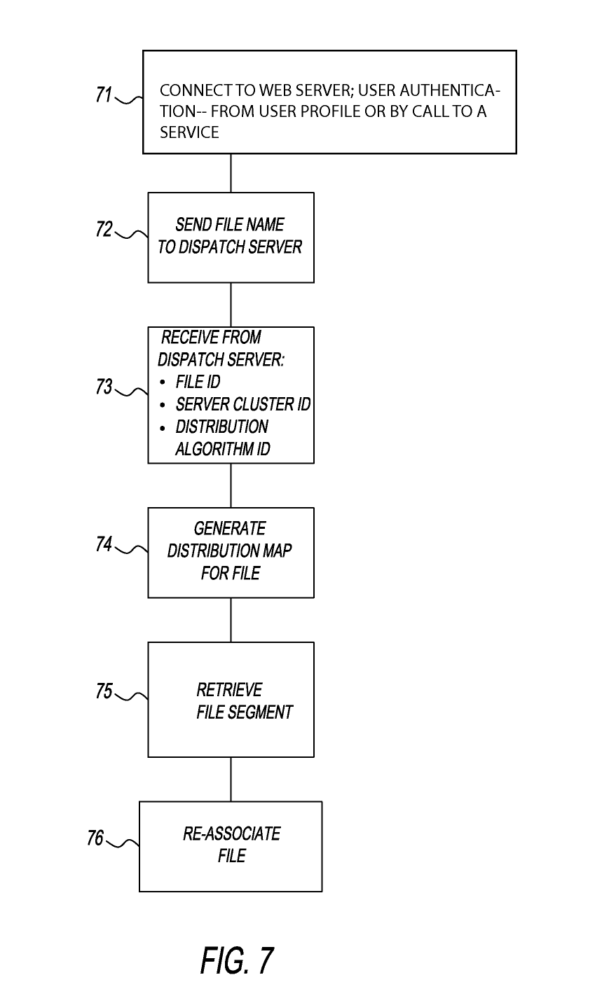

Details of a process for retrieving and re-assembling a file, in accordance with an embodiment, are shown in the flowchart of FIG. 7. The user connects to the web server and transmits required authentication information. Although there is a user profile, authentication can be by a call to a server such as Facebook. Facebook allows remote sites to do this through their APIs. Thus, the user profile may be in a locally attached storage to the Web Server or it may be remote, (step 71). The client sends the filename of the desired file to the dispatch server (step 72), which responds with the file identifier, the server cluster identifier, and the distribution algorithm identifier (step 73). The client then proceeds (step 74) to generate the distribution map for the desired file, and retrieves the necessary file segments 66-68 from the various storage locations (step 75). The client re-assembles the file (step 76), essentially reversing the file storage process (compare FIGS. 2 and 3).

It should be noted that the fully assembled file is present only at the client; the retrieved file is never transmitted as a contiguous whole over the network.

It will be appreciated that the above-described methods permit file storage and retrieval with a high level of security, since the original file, the re-created file, and the distribution map for the file segments are never transmitted over the network. Furthermore, the file segments may be encrypted either before or after segmentation, so that the file may be stored both encrypted and segmented.

While the disclosure has been described in terms of specific embodiments, it is evident in view of the foregoing description that numerous alternatives, modifications and variations will be apparent to those skilled in the art. Some examples of variations are:
1) For large files, apply a standard compression technique (such a zip) to the file segments, for more efficient and rapid network transmission).
2) Include a timer function in the client application which will cause the automatic deletion of both the file and client application after a certain period of time)
   Also note that the client application can have many different embodiments, for example:
1) A native Windows implementation (for-instance .NET based)
2) A java-based implementation,
3) a browser-based implementation
4) an implementation specific to a mobile device (for-instance an Objective-C implementation for the Apple iPhone, iPod touch, etc, or an implementation for devices running the Android operating system, or a Blackberry specific implementation.

Accordingly, the disclosure is intended to encompass all such alternatives, modifications and variations which fall within the scope and spirit of the disclosure and the following claims.

1. A method for segmenting and storing a data file, comprising:
transmitting identifying information for the file to a dispatch server;
receiving from the dispatch server a file identifier, a storage location identifier, and a distribution algorithm identifier;
performing the distribution algorithm in accordance with the received distribution algorithm identifier;
generating a distribution map for segments of the file in accordance with the distribution algorithm; and
transmitting the file segments to one or more storage locations in accordance with the distribution map;
wherein the file segments are transmitted to the storage locations either serially or in parallel.

2. A method according to claim 1, wherein
the method is performed at a client system executing a client application,
the storage location identifier identifies a server cluster,
the dispatch server and the server cluster are located at a third-party facility that is physically and/or logically remote from the client, and
said transmitting is performed over a wide-area network (WAN).

3. A method according to claim 1, further comprising retrieving the distribution algorithm in accordance with the distribution algorithm identifier, and wherein neither the distribution algorithm nor the distribution map is transmitted over a wide-area network (WAN).

4. A method according to claim 3, wherein a plurality of distribution algorithms are provided for retrieval, so that the distribution algorithm and the distribution map for one stored file are distinct from the distribution algorithm and the distribution map for another stored file.

5. A method according to claim 1, wherein the distribution map indicates for each file segment a segment size and a storage destination for that segment.

6. A method according to claim 1, wherein performing the distribution algorithm further comprises
encrypting the file identifier received from the dispatch server to obtain a first encrypted value;
subsequently encrypting the first encrypted value to obtain an additional encrypted value; and
repeating said subsequent encrypting step, so that the distribution map includes an array of encrypted values, each entry in the array indicating a size and a storage destination of one file segment.

7. A method according to claim 1, further comprising encrypting a file segment before transmitting the file segment.

8. A method according to claim 1, further comprising retrieving a stored segmented data file, including:
transmitting identifying information to the dispatch server for the stored file;
receiving from the dispatch server:
a file identifier for the stored file,
a server cluster identifier for the segments of the stored file,
and a distribution algorithm identifier for the stored file;
performing the distribution algorithm in accordance with the distribution algorithm identifier for the stored file, thereby generating the distribution map for the stored file segments;
retrieving the stored file segments in accordance with the distribution map; and
re-assembling the file segments to obtain the file.

9. A method according to claim 8, wherein the method is performed at a client system executing a client application, and wherein none of the distribution algorithm, the distribution map, and the re-assembled file are transmitted over the WAN.

10. A method according to claim 1, further comprising transmitting user authentication information to a web server connected to the dispatch server.

11. A method for storing a data file, comprising:
receiving identifying information for the file from a client;
transmitting to the client a file identifier, a storage location identifier, and a distribution algorithm identifier; and
receiving file segments at one or more storage locations, in accordance with a distribution map generated by the client, the distribution map generated according to the distribution algorithm.

12. A method according to claim 11, wherein
the method is performed by a dispatch server,
the storage location identifier identifies a server cluster,
the dispatch server and the server cluster are located at a third-party facility that is physically and/or logically remote from the client, and
said transmitting is performed over a wide-area network (WAN).

13. A method according to claim 11, wherein a plurality of distribution algorithms are provided for transmission, so that the distribution algorithm and the distribution map for one stored file are distinct from the distribution algorithm and the distribution map for another stored file.

14. A method according to claim 11, wherein the distribution map indicates for each file segment a segment size and a storage destination for that segment.

15. A method according to claim 11, further comprising retrieving a stored segmented data file, including:
receiving identifying information for the stored file from the client;
transmitting to the client:
a file identifier for the stored file,
a server cluster identifier for the segments of the stored file, and a distribution algorithm identifier for the stored file; and
transmitting the stored file segments to the client, in accordance with the distribution map generated by the client, for re-assembly by the client.

16. A method according to claim 15, wherein the method is performed at a dispatch server connected to a client system over a wide-area network (WAN), and wherein none of the distribution algorithm, the distribution map, and the re-assembled file are transmitted over the WAN.

17. A system for storing and retrieving a data file, comprising:
a client system;
a dispatch server connected to the client system; and
one or more storage locations for storing segments of the file,
wherein
the dispatch server is configured to transmit to the client system
a file identifier,
a server cluster identifier indicating the storage location, and
a distribution algorithm identifier;
the client system is configured to execute a client application for
performing a distribution algorithm identified by the distribution algorithm identifier,
generating a distribution map for segments of the file, in accordance with the distribution algorithm, and
transmitting the file segments to the storage location in accordance with the distribution map.

18. A system according to claim 17, wherein a plurality of distribution algorithms are provided for transmission by the dispatch server, so that the distribution algorithm and the distribution map for one stored file are distinct from the distribution algorithm and the distribution map for another stored file.

19. A system according to claim 17, further comprising a web server connected to the dispatch server, the web server configured to receive user authentication information from the client system.

20. A system according to claim 19, wherein the dispatch server and the web server are located at a third-party facility that is physically and/or logically remote from the client, and said transmitting is performed over a wide-area network (WAN).
